(19) United States
(12) Patent Application Publication
(10) Pub. No.: US 2009/0122536 A1
(43) Pub. Date: May 14, 2009

(54) OPERATIONAL LAMP

(75) Inventor: Manfred Scholz, Seitingen-Oberflacht (DE)

Correspondence Address: LEWIS AND ROCA LLP, 1663 Hwy 395, Suite 201, Minden, NV, 89423, US

(73) Assignee: BERCHTOLD HOLDING GmbH, Tuttlingen (DE)

(21) Appl. No.: 11/997,532

(22) PCT Filed: Jul. 11, 2006
(86) PCT No.: PCT/EP06/06774

§ 371 Date: Jun. 25, 2008

(30) Foreign Application Priority Data
Aug. 2, 2005 (DE) 10 2005 036 275.3

(51) Int. Cl. F21V 33/00; F21V 21/00; F21V 7/00

(52) U.S. Cl. 362/234; 362/249.02; 362/249.06; 362/247

(57) ABSTRACT

The invention relates to an operational lamp comprising at least one light source that is situated in a lamp body and an optical element, which is designed to direct the visible radiation of the light source onto an operational field. According to the invention, said lamp comprises several light emitting diodes as the light sources.

The present invention relates to a surgical lamp comprising at least one light source arranged in a lamp body and an optical means to direct the visible radiation of the light source to a surgical field.

Surgical lamps of this kind are generally known, with halogen lamps or discharge lamps being used as the light source and reflectors being used as the optical means.

It is the object of the invention to provide a surgical lamp which is versatile in use and has a favorable construction shape for use in an operating room.

This object is satisfied by the features of claim 1.

In accordance with the invention, the light source of the surgical lamp has a plurality of light emitting diodes, whereby completely new solution approaches for the lighting of the surgical field result. A shallow construction shape of the surgical lamp is possible due to the use of light emitting diodes as the light source, which is advantageous both in an esthetic respect and in a technical flow respect since in this case the air flow of a supply air ceiling located above the surgical area is not impeded. At the same time, a plurality of additional application options which can be integrated into a surgical lamp results due to the good dimmability of light emitting diodes and due to their optical properties.

Advantageous embodiments of the invention are described in the description, in the drawing and in the dependent claims.

It is thus advantageous for the light emitting diodes to be arranged in ring shape, and in particular in circular ring shape, in the lamp body. This opens up the possibility, on the one hand, of providing attachments or additional light sources at the center of the ring. On the other hand, the lamp body can be designed such that air can flow through the housing ring formed by it in its interior, i.e. in the interior of the ring. The surgical lamp hereby represents a lesser obstacle in a technical flow aspect and the flow paths for laminar flow are impeded less when supply air ceilings are used so that particles and germs can be kept away from the surgical field in an optimized manner.

It is also advantageous in this context for the lamp body or the housing ring to be made comparatively shallow, whereby a plate-shaped lamp body results overall which is, however, open in its interior.

In accordance with a further advantageous embodiment, the lamp body has a central mount for an attachment, in particular for an additional light source. For example, a special spot light, a cold light source or a camera can be arranged in the central mount or other tools for the surgical team can be provided therein. A central additional light source can serve for depth illumination and for direct object illumination. In this connection, it may be advantageous for a gas discharge lamp or a halogen lamp to be provided at the center of the lamp body which can in particular be switched separately, that is independently, of the light emitting diodes. In this manner, a depth illumination can, for example, be switched in directly when the surgeon requires it.

In accordance with a further advantageous embodiment, a plurality of optical modules are provided which each include at least one light emitting diode and an associated reflector and/or collimator as an optical means. Such optical modules can be produced as very small units, for example as cost-effective injection molded parts. An approximately parallel light radiation is generated by the collimator, with radiation angles in the order of magnitude of 4° being possible. Since the light emitted by the light emitting diode is already collimated at the light source, this enables a highly efficient coupling of the emitted light into the ray path. In addition, a plastic collimator, for example of a high-refractive plastic, can be put on which effects a further bundling of the light beam and thus the desired low radiation angle by means of total reflection.

It is particularly advantageous for the optical modules to be arranged movably, for example pivotably, since in this case a change in the light field size is possible by pivoting the optical modules. Focusing can also be achieved by a movement of the optical modules relative to a reflector or collimator fixed to the housing. Every light emitting diode can thus have an associated focusing optical system, with focusing being achieved, for example, by adjustment of the relative spacing between the light emitting diode and the focusing optical system. It is particularly advantageous for all focusing optical systems of the surgical lamp to be adjustable, for example pivotable, together by an adjustment element. It is equally possible to adjust, in particular to pivot, the optical modules of the surgical lamp together by such an adjustment element, for example an adjustment ring.

In accordance with a further advantageous embodiment, a ring shaped reflector is provided which is arranged, for example, at the lower side of the lamp body or is integrated into the lamp body at the lower side thereof. The diameter of the lamp housing is used to the full by such a ring reflector and maximally diverging angles of incidence with ideal hard shadow freedom are achieved. It is alternatively naturally also possible to allow the light emitting diodes to be incident into the surgical field in a directly converging and diverging manner.

In accordance with a further advantageous embodiment of the invention, the optical means can effect both a converging ray discharge and a diverging ray discharge. For example, two reflectors can be provided of which one effects a converging ray discharge and the other a diverging ray discharge. Alternatively, different converging and diverging reflector sections can also be provided within a reflector. It is also possible to provide converging and diverging optical modules within the surgical lamp so that both converging and diverging light rays are generated, which is advantageous for a shadow-free illumination of the surgical area.

In accordance with a further advantageous embodiment of the invention, the optical modules are made such that every single optical module completely illuminates the light field within a predetermined light field diameter. In other words, the light field within the predetermined light field diameter is not illuminated by different optical modules in different segments, but rather each optical module provides a complete and uniform illumination of the light field within the predetermined light field diameter to ensure a freedom from shadow which is as large as possible.

In accordance with a further advantageous embodiment, a fan can be provided for the cooling of the light source within a closed housing in which the light source is located to effect a compulsory flow inside the closed housing which leads the heat away from the light source. In this manner, on the one hand, head is led away from the light source, for example a light emitting diode provided with a heat sink. At the same time, it is ensured by the closed housing, however, that the flow above the surgical field is not negatively impaired.

In accordance with a further advantageous embodiment of the invention, a liquid cooling can be provided for the cooling of the light source. In this manner, the heat generated by the light source, which in particular has to be led away for a problem-free operation with light emitting diodes, can be led away in an efficient manner. The cooling of the light source preferably takes place using cooling water in this case.

In accordance with a further aspect of the invention, the surgical lamp has at least one illuminant, for example one or more of the already mentioned light emitting diodes, whose intensity maximum is in the region of approximately 450 nm, with a control device being provided with which this additional illuminant can be controlled independently of the light source, that is of the remaining light emitting diodes, for example. The realization is utilized in this embodiment that light also has a physiological effect on the observer. A second portion of the optic tract is activated by light of a specific wavelength in the blue color spectrum which activates the metabolism and the endocrine glands to rhythmic activity as an energetic portion. It is known that the release of a hormone (melatonin) is inhibited by daylight, which serves for the activation of the circulation since melatonin regulates the day/night rhythm (circadian rhythm). The secretion of melatonin at night is effected by the blue light by photosensors in the human eye which are distributed uniformly over the retina and which cannot resolve an image pattern. Since surgical teams frequently have to work for many hours, and often also at night, under stress at very high concentration, the surgeon can be supported in his work by a suitable selection of the light spectrum such that he can also work at maximum concentration capability during a difficult emergency operation at night. The suppression of the melatonin secretion can be excited by the additional illuminant with an intensity maximum in the range of approximately 450 nm such that the performance capability of the surgical team is increased, even if it has to operate for several hours at night or during the day.

It is particularly advantageous for the additional illuminant to be able to be switched in automatically by the control device in dependence on specific parameters. Such parameters can, for example, be the current time (time of day) or the current operating duration of the light source from which a conclusion can be drawn on the already past operating time. It is, for example, possible to increase the radiation of the illuminant when the current time is progressing, i.e. when it is increasingly becoming night. An increase can also take place when the light source increasingly remains switched on, i.e. when the operation has, for example, lasted several hours. Fatigue can hereby be prevented, on the one hand, and an increase in performance can even be effected, on the other hand.

As has already been mentioned above, the illuminant for the melatonin suppression can either be an additional illuminant. However, it is also possible to control the color spectrum of the surgical lamp such that the desired wavelength range of approximately 450 nm is radiated at an increased intensity or at an increasingly increased intensity. Furthermore, the illuminant for the melatonin suppression does not necessarily have to radiate in the direction of the surgical field. The radiation can rather also take place to the side or to the top, i.e. indirectly. Furthermore the illuminant can also be arranged in a separate lamp body.

In accordance with a further aspect of the invention, the surgical lamp has a control device which is provided with an input means with which a reference wavelength or a reference wavelength range can be selected, whereupon the light emitting diodes of the surgical lamp, and optionally further light emitting diodes, can be controlled by the control device such that the radiation directed from the surgical lamp to the surgical field is mainly emitted or is only emitted at the reference wavelength or in the reference wavelength range. In this embodiment, the surgical lamp in accordance with the invention additionally has, beside the possibility of illuminating the surgical field, a diagnosis light (reference light) in order, for example, to localize tumors and different tissues simply and reliably. It must be mentioned in this connection that the reference light or the diagnosis light do not necessarily have to be in the visible spectrum.

Since light penetrates to different depths in human tissue, a simple distinction between different tissues can take place by the direct radiation with narrow band light and, optionally, contrast enhancing measures. A possibility of such a diagnosis is the fluorescence diagnosis which is based on the selective accumulation of specific dyes in tumor cells which become visible after excitation with light at a specific wavelength.

In the fluorescent diagnosis, body tissue is illuminated directly with blue light of lower intensity (reference light), for example, whose diffusely backscattered portion is detected together with the created fluorescent light. The intensity of the blue light is thus set such that normal tissue appears blue. The amplified red fluorescence of a previously applied active agent (for example 5-aminolevulinic acid), however, effects a color shift toward red. By observation of the surgical area with an optical filter which filters the blue light radiation, for example with the help of goggles or an electronic camera which effects the filtering electronically, malign or pathological cells can be recognized since the active agent accumulates more in those cells than in healthy cells.

A further diagnosis possibility results by radiation with the reference wavelength since inflammations in a tissue generate much darker structures than the surrounding healthy tissue by a modified absorption and reflection behavior. An unambiguous diagnosis is made possible using a spectrally narrow band light, which is only possible with the help of strong filtering with conventional light sources. Since colored light emitting diodes generate quasi-monochromatic light at a bandwidth of +/− 20 nm and a true color of practically 100%, light emitting diodes are particularly suitable as a diagnosis light. It is particularly advantageous in this connection for the aforesaid control device to have a switching means to switch between an operating mode with a reference radiation and an operating mode with daylight-like radiation since it is possible in this manner to switch particularly fast between conventional surgical operation and diagnosis operation.

In accordance with a further advantageous embodiment, the control device has a switching means with which it is possible to switch between a reference radiation in the infrared spectrum and a reference radiation in the ultraviolet spectrum. Such a surgical lamp can be used for different diagnosis applications, with it being possible to switch fast and reliably in a simple manner between the different applications in the infrared spectrum and in the ultraviolet spectrum.

It is advantageous in order to make the fluorescent spectrum visible for an electronic camera to be built into the surgical lamp whose evaluation electronics effect the desired filtering.

The present invention will be described in the following with reference to an advantageous embodiment and to the drawing. There are shown:

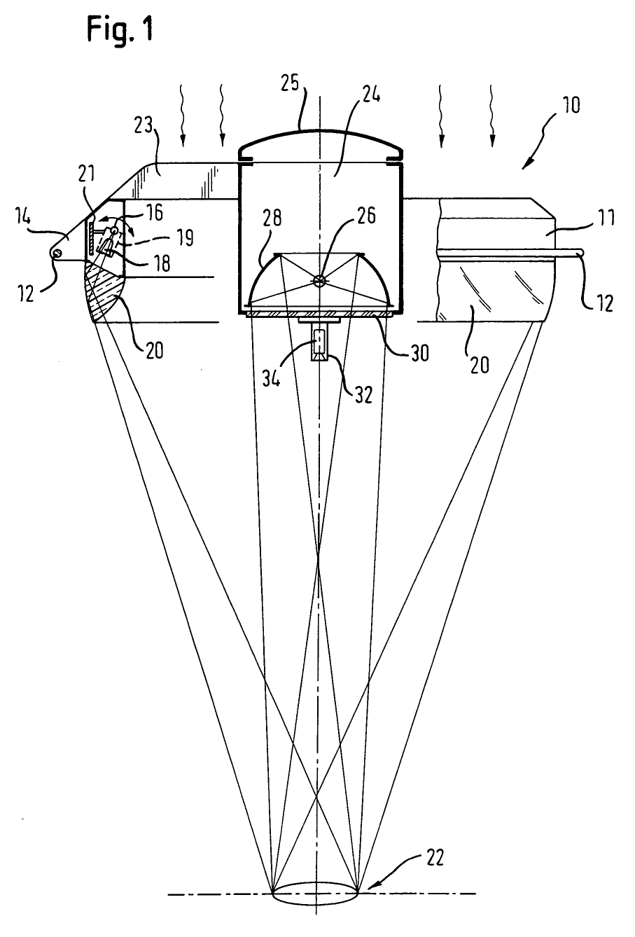

FIG. 1 a partially sectioned side view of an operating light;

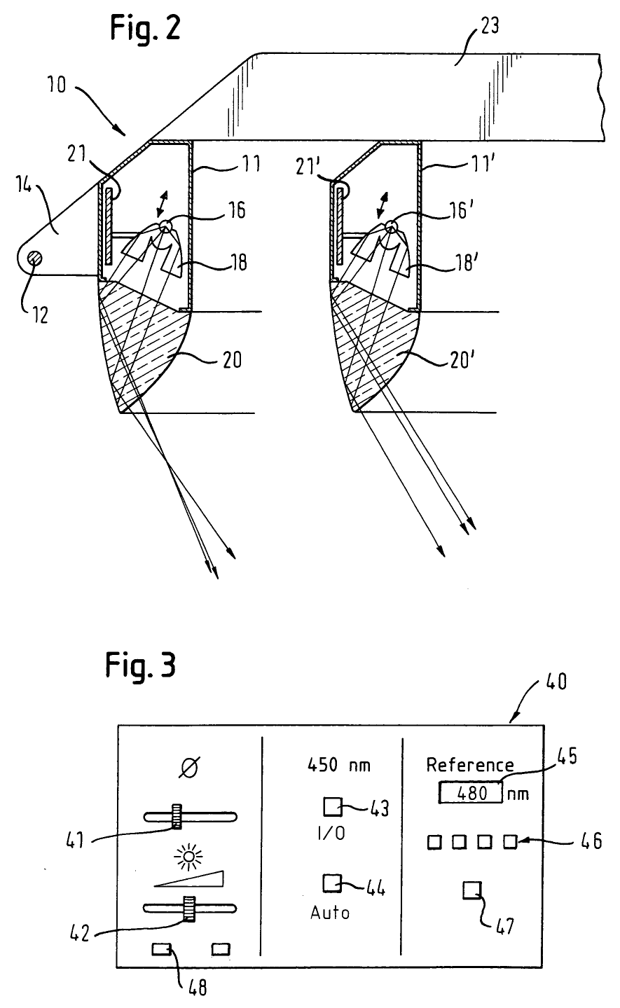

FIG. 2 a partially sectioned side view of a further embodiment of a surgical lamp; and

FIG. 3 a plan view of a control device.

The surgical lamp shown in FIG. 1 has a lamp body 10 which is made in ring shape and which is surrounded at its outer periphery by a railing 12 which is fastened to the outer side of the lamp body 10 via support elements 14. In this connection, the lamp body 10 is made as a housing ring which is made in circular ring shape in the embodiment shown and through whose ring interior air can flow, which is indicated by the vertical arrows in FIG. 1. A plate-shaped structure of the lamp body 10 results overall due to the low height of the housing ring.

A light source is arranged in the interior of the lamp body 10 in the form of a plurality of light emitting diodes 16 which illuminate a surgical field 22 via a collimator 18 and a ring shaped reflector 20. The light emitting diodes 16 are correspondingly arranged in the lamp body 10 in ring shape or in circular ring shape.

A central mount 24 is provided in the interior of the housing ring 11 and is made in beaker form and has an additional light source 26 in the form of a discharge lamp in its interior. The radiation of the discharge lamp 26 is directed vertically downwardly via a parabolic reflector 28 in the interior of the central mount 24 to effect depth illumination of the surgical field.

A transparent end plate 30 is provided at the lower side of the central mount 24 and a handle 32 into which a CCD cameral 34 is integrated is arranged at its center. The upper side of the central mount 24 is provided with a removable housing cover 25. The surgical lamp itself is fastened to a stand via joint arms which are not shown. The housing ring 11 is connected to the central mount 24 via three radially extending supports 23, said central mount in turn being connected to the joint arm which is not shown.

As can be recognized from FIG. 1, in this embodiment the light emitting diodes 16 and the associated collimator 18 are integrated into an optical module 19 which is shown by dashed lines and which can be pivoted in the direction of the double arrow shown. All the optical modules 19 are pivotable together via an adjustment ring 21 which extends in the peripheral direction inside the housing ring 11 and which is provided with a slanting toothed arrangement to correspondingly pivot the optical modules which have a corresponding toothed arrangement. An electrically actuable servo motor is provided for the drive of the adjustment ring 21.

As FIG. 1 shows, the reflector 20 is made in ring shape and is fastened to the lower side of the housing ring 11 such that it sealingly terminates the interior of the housing ring. The reflector 20 consists of high-refractive plastic and reflects the incident radiation by total reflection at its outer jacket surface. The optical module 19 can be pivoted by actuation of the adjustment ring 21, whereby the diameter of the light spot formed on the surgical field 22 varies.

FIG. 2 shows an alternative embodiment of a surgical lamp, with the same reference numerals being used for the same components.

In the surgical lamp shown in FIG. 2, the lamp body has a first housing ring 11 which is made in the same way as in the embodiment of FIG. 1. In addition, a second housing ring 11′ is provided which has a smaller diameter than the first housing ring 11, with both housing rings being arranged concentrically to one another and being fastened to the supports 23. Light emitting diodes 16 and 16′ are in turn arranged in the interior of the two housing rings 11 and a respective collimator 18, 18′ is arranged after each of them. The lower side of the two housing rings 11 and 11′ is in each case closed by a ring shaped reflector 20, 20′ of high-refractive plastic.

The two reflectors 20 and 20′ differ, however, in the design (curvature) of the outer peripheral surface which effects a total reflection of the incident radiation. In this manner, the outer ring reflector 20 causes a converging ray discharge, whereas the inner ring reflector 20′ effects a diverging ray discharge.

The respective collimators 18 and 18′ are in turn adjustable via adjustment rings 21, 21′, with in this embodiment, however, no pivot movement taking place, but rather an adjustment of the relative spacing between the light emitting diode and the collimator along the optical axis, i.e. in the direction of the double arrow shown. In this embodiment, the light emitting diodes 16, 16′ are thus not connected to the collimators 18, 18′ to form a unit. The collimators 18, 18′ are rather constructionally separate optical modules which are movable independently of the light emitting diode 16.

Light emitting diodes are particularly advantageous in which the light emitted by the chip is already collimated at the light source since a highly efficient coupling of the emitted light into the ray path is hereby made possible. In addition, a plastic collimator can be subsequently connected which effects a further bundling of the light ray and thus a radiation angle in the order of magnitude of 4° which is as small as possible by means of total reflection. Lens elements or reflector elements can also be integrated in the chip or into the optical modules. Furthermore, high-performance light emitting diodes with an integrated heat sink are particularly suitable.

To obtain a color mixture which is as variable as possible, red, yellow and blue light emitting diodes can be used, for example, with the resulting color being able to be regulated directly via color sensors.

The control 40 shown in FIG. 3 includes a power supply (24 V) and an interface USB/DMX for the connection of a control unit. The different LED groups are controlled with variable operating voltages via the color control interface to achieve the desired color mixing. It can additionally be sensible also to use white light emitting diodes.

All the colors of the visible spectrum as well as white operating room light with different color temperatures can be generated using the color change system described above. The use of amber and white light emitting diodes is to be preferred for the control of different color temperatures, e.g. 3000 to 6000 K.

The control 40 shown in FIG. 3 has a tripartite input field, with the left hand part being provided for the control of the regular operating room light. The light field diameter can be varied with the help of a regulator 41 in that the adjustment ring or rings 21, 21′ are actuated via the servo motor which is not shown. The brightness can be varied with the aid of the regulator 42.

The part of the operating panel of the control 40 in the middle in FIG. 3 serves to switch in radiation in the wavelength range of approximately 450 nm with increased intensity, which can take place by direct control of the light emitting diodes 16, 16′ or of additional light emitting diodes. The control is configured in this respect such that the conventional operating room light remains unchanged, even when the light emitting diodes required for the radiation of 450 nm radiate at increased intensity. The increase of the radiation in the range of 450 nm (called excitation radiation in the following) can be permanently switched in by a push button 43. Alternatively, an automatic operation can be triggered with the aid of the push button 44 in which the excitation radiation is automatically switched in with the help of a preset program in dependence on the current time and/or on the current operating period of the surgical lamp. In this connection, the excitation radiation is constantly increased as the operating time of the surgical lamp increases during an operation and as the time of day progresses further. For this purpose, the control 40 has a built-in clock and a time measuring unit which is activated on the switching on of the surgical lamp such that a conclusion can be drawn on the duration of an operation.

The region of the operating panel of the control 40 at the right in FIG. 3 has a display 45 as well as diverse input means 46 with which a reference wavelength or a reference wavelength range can be selected. In the representation of FIG. 3, a reference wavelength of 480 nm is selected, which has the result that, after release of the reference light by actuation of a push button 47, the discharge lamp 26 is switched off and all the light emitting diodes 16, 16′ are controlled such that the radiation directed from the surgical lamp to the surgical field 22 is output very predominantly or exclusively at the selected reference wavelength or in the selected reference wavelength range. A desired diagnosis light can be set in a simple manner in this manner. A switchover is made between operation with diagnosis light and operation with conventional operating room light by multiple actuation of the push button 47. The gas discharge lamp 26 can be switched separately by a further push button 48.

The camera 34 built into the handle 32 of the surgical lamp is connected to the control 40, with a filtering system being provided in the control which filters the generated reference radiation such that only the generated fluorescence spectrum is reproduced on a monitor (not shown).

### REFERENCE NUMERAL LIST

10 lamp body

11, 11′ housing ring

12 railing

14 holder

16, 16′ light emitting diodes

18, 18′ collimators

19 optical module

20, 20′ reflector

21, 21′ adjustment ring

22 surgical field

23 support

24 central mount

25 housing cover

26 gas discharge lamp

28 parabolic reflector

30 transparent plate

32 handle

34 electronic camera

40 control device

41, 42 regulator

43, 44 push button

45 display

46-48 push button

1. A surgical lamp having at least one light source arranged in a lamp body and an optical means to direct the visible radiation of the light source to a surgical field, characterized in that the light source has a plurality of light emitting diodes.

2. A surgical lamp in accordance with claim 1, characterized in that the light emitting diodes are arranged in the lamp body in ring shape, in particular in circular ring shape.

3. A surgical lamp in accordance with claim 1, characterized in that the lamp body has at least one housing ring whose ring interior can be flowed through and in which the light emitting diodes are arranged.

4. A surgical lamp in accordance with claim 1, characterized in that the lamp body is made in plate shape.

5. A surgical lamp in accordance with claim 1, characterized in that the lamp body has a central mount for an attachment, in particular for an additional light source.

6. A surgical lamp in accordance with claim 1, characterized in that one of a gas discharge lamp or and a halogen lamp is in particular provided at the center of the lamp body and is in particular separately switchable.

7. A surgical lamp in accordance with claim 1, characterized in that a plurality of optical modules are provided which are in particular arranged movably and which include at least one of a reflector and a collimator as the optical means.

8. A surgical lamp in accordance with claim 7, characterized in that the spacing between a light emitting diode and an associated optical module can be varied by an adjustment means.

9. A surgical lamp in accordance with claim 7, characterized in that a light emitting diode is integrated into each optical module.

10. A surgical lamp in accordance with claim 7, characterized in that a plurality of optical modules can be adjusted together by an adjustment element, in particular by an adjustment ring.

11. A surgical lamp in accordance with claim 1, characterized in that each light emitting diode has an associated focusing optical system as the optical means, with in particular all the focusing optical systems being able to be adjusted, in particular pivoted, together by an adjustment element.

12. A surgical lamp in accordance with claim 1, characterized in that a ring shaped reflector is provided which is in particular arranged at the lower side of the lamp body.

13. A surgical lamp in accordance with claim 1, characterized in that the reflector consists of plastic and the introduced radiation is reflected by means of total reflection.

14. A surgical lamp in accordance with claim 1, characterized in that at least one illuminant is provided whose intensity maximum is in the region of approximately 450 nm and in that a control device is provided with which the illuminant can be controlled independently of the light source.

15. A surgical lamp in accordance with claim 14, characterized in that the illuminant can be switched on automatically by the control device with reference to at least one parameter which is selected from the following group: current time, and current operating duration of the surgical lamp.

16. A surgical lamp in accordance with claim 15, characterized in that the illuminant has a luminous flux that is automatically variable by the control device in dependence on the current operating duration of the surgical lamp.

17. A surgical lamp in accordance with claim 1, characterized in that a control device is provided which has an input means with which one of a reference wavelength and a reference wavelength range can be selected, whereupon the light emitting diodes of the surgical lamp are controllable by the control device such that the radiation directed from the surgical lamp to the surgical field is output substantially at one of the reference wavelength and the reference wavelength range.

18. A surgical lamp in accordance with claim 17, characterized in that the control device has a switching means to switch over between an operating mode with reference radiation and an operating mode with daylight-like radiation.

19. A surgical lamp in accordance with claim 17, characterized in that the control device has a switching means to switch over between a reference radiation in the infrared spectrum and a reference radiation in the ultraviolet spectrum.

20. A surgical lamp in accordance with claim 17, characterized in that it has an electronic camera system which is made for the recording of a fluorescence spectrum.

21. A surgical lamp in accordance with claim 1, characterized in that the optical means generates both converging light rays and diverging light rays.

22. A surgical lamp in accordance with claim 1, characterized in that a fan is provided for the cooling of the light source inside a closed housing.

23. A surgical lamp in accordance with claim 1, characterized in that a liquid cooling is provided for the cooling of the light source.

24. A surgical lamp in accordance with claim 1, characterized in that a ring shaped reflector is provided which is integrated into the lamp body.

25. A surgical lamp in accordance with claim 1, characterized in that a control device is provided which has an input means with which one of a reference wavelength and a reference wavelength range can be selected, whereupon the further illuminants of the surgical lamp are controllable by the control device such that the radiation directed from the surgical lamp to the surgical field is output substantially at one of the reference wavelength and the reference wavelength range.
